(19) United States
(12) Patent Application Publication
(10) Pub. No.: US 2012/0174057 A1
(43) Pub. Date: Jul. 5, 2012

(54) INTELLIGENT TIMESHEET ASSISTANCE

(75) Inventors: NANJANGUD C. NARENDRA, BANGALORE (IN); RENUKA S. RAJAN, BANGALORE (IN); ARTHUR G. RYMAN, MARKHAM (CA); BIKRAM SENGUPTA, BANGALORE (IN); RAJESH P. THAKKAR, BANGALORE (IN)

(73) Assignee: INTERNATIONAL BUSINESS MACHINES CORPORATION, ARMONK, NY (US)

(21) Appl. No.: 13/417,070

(22) Filed: Mar. 9, 2012

Related U.S. Application Data
(63) Continuation of application No. 13/007,796, filed on Jan. 17, 2011.

(30) Foreign Application Priority Data
Jul. 14, 2010 (CA) 2707916

(51) Int. Cl. G06F 9/44

(52) U.S. Cl. 717/101

(57) ABSTRACT

A timesheet assistant mines development items in a repository of a computer to form identified development items. Development context information and effort indicators, associated with the identified development items, are extracted. Statistical analysis is applied to tasks of the identified development items using the effort indicators. Efforts expended on the tasks are predicted using historical data to create effort estimates. Developer reported efforts for the identified items are received, and a timesheet is generated using the development context information, the effort estimates and the developer reported effort. The timesheet is presented for review, verification, and approval.

### CROSS-REFERENCE TO RELATED APPLICATION

The present application claims a priority filing date of Jul. 14, 2010 from Canada Patent Application No. 2707916, which is incorporated herein in its entirety by reference.

The present application is a continuation of U.S. patent application Ser. No. 13/007,796 (Atty. Docket No. CA920100026US1), filed on Jan. 17, 2011, and entitled, “Intelligent Timesheet Assistance,” which is incorporated herein by reference.

### BACKGROUND

This disclosure relates generally to project management in a data processing system, and, more specifically, to calculating and tracking the effort required to complete a software development task in the data processing system.

In many organizations, software developers are required to report their effort in timesheets. This process is both tedious and error-prone since software developers typically work on multiple tasks and have to recall and estimate the effort reported on each task. In addition, the reported information may not accurately reflect the actual work performed on the tasks due to a variety of organizational pressures. One known approach to this problem is to monitor the activity on the developer's computer by tracking keyboard and window activity. The drawbacks of this approach are that it is very invasive, violates developer's privacy, and does not account for activity performed away from the developer's computer.

Timesheet data is an important instrument used in software project management for tracking developer activities. In a typical project, timesheet data is used to determine the cost of the project by identifying the resources (team members), the effort expended by them and the cost of the resources. Moreover, organizations following process improvement models such as the Capability Maturity Model Integration (CMMI® is a Trademark of Carnegie Mellon University) need to use historical information from past projects to help define baselines that are used to model and predict attributes of future projects. Data available in the timesheets is an important source of historical development effort. Hence, in every software development organization, timesheet data becomes an important aspect of project management.

Team members fill out timesheets periodically (e.g. daily, weekly or monthly), to report the effort spent on different development tasks undertaken during the time period. Project managers review the effort data submitted, and either approve a timesheet when the effort is deemed to be reasonable given the nature of activities undertaken, or reject the timesheet. Timesheets typically list a set of activities and the effort spent on each activity.

A project manager who approves or rejects the timesheets often bases his decision on quick, subjective judgment reviews of them. The review is typically quick because there may be a large number of timesheets to review, and there is no additional information available to help validate the effort reported for each of the activities. When a timesheet is rejected, the developer has to either correct the submitted effort, or provide justification for the reported effort. In addition, the timesheets may be shared with customers, who will review the timesheets carefully for indications of incorrect effort billing. Again, justification may be required for the effort claimed including the size and complexity of work carried out, expertise of developers involved, etc. The justification can become a challenging exercise, since the environments for conducting development work and reporting effort or managing projects have traditionally been disconnected.

### SUMMARY

According to one embodiment, a computer-implemented process for timesheet assistance mines development items in a repository of a computer to form identified development items, extracts development context information, and effort indicators associated with the identified development items and applies statistical analysis to tasks of the identified development items using the effort indicators. The computer-implemented process predicts effort expended on the tasks using historical data to create effort estimates, receives developer reported effort for the identified items, generates a timesheet using the development context information, effort estimates and developer reported effort and presents the timesheet for review and approval.

According to another embodiment, a computer program product for timesheet assistance comprises a computer recordable-type media containing computer executable program code stored thereon. The computer executable program code comprises computer executable program code for mining development items in a repository of a computer to form identified development items, computer executable program code for extracting development context information, and effort indicators associated with the identified development items, computer executable program code for applying statistical analysis to tasks of the identified development items using the effort indicators, computer executable program code for predicting effort expended on the tasks using historical data to create effort estimates, computer executable program code for receiving developer reported effort for the identified items, computer executable program code for generating a timesheet using the development context information, effort estimates and developer reported effort and computer executable program code for presenting the timesheet for review and approval.

According to another embodiment, an apparatus for timesheet assistance comprises a communications fabric, a memory connected to the communications fabric, wherein the memory contains computer executable program code, a communications unit connected to the communications fabric, an input/output unit connected to the communications fabric, a display connected to the communications fabric and a processor unit connected to the communications fabric. The processor unit executes the computer executable program code to direct the apparatus to mine development items in a repository of a computer to form identified development items, extract development context information, and effort indicators associated with the identified development items, apply statistical analysis to tasks of the identified development items using the effort indicators, predict effort expended on the tasks using historical data to create effort estimates, receive developer reported effort for the identified items, generate a timesheet using the development context information, effort estimates and developer reported effort and present the timesheet for review and approval.

### BRIEF DESCRIPTION OF THE SEVERAL VIEWS OF THE DRAWINGS

FIG. 1 is a block diagram of an exemplary data processing system operable for various embodiments of the disclosure;

FIG. 2 is a block diagram of components of a timesheet assistance system, in accordance with various embodiments of the disclosure;

FIG. 3 is a block diagram of factors typically impacting effort, in accordance with one embodiment of the disclosure;

FIG. 4 is a flowchart of a high level view of a process of timesheet assistance, in accordance with one embodiment of the disclosure; and

FIG. 5 is a flowchart of a detail view of the process of timesheet assistance of FIG. 4, in accordance with one embodiment of the disclosure.

### DETAILED DESCRIPTION

As will be appreciated by one skilled in the art, aspects of the present invention may be embodied as a system, method or computer program product. Accordingly, aspects of the present invention may take the form of an entirely hardware embodiment or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

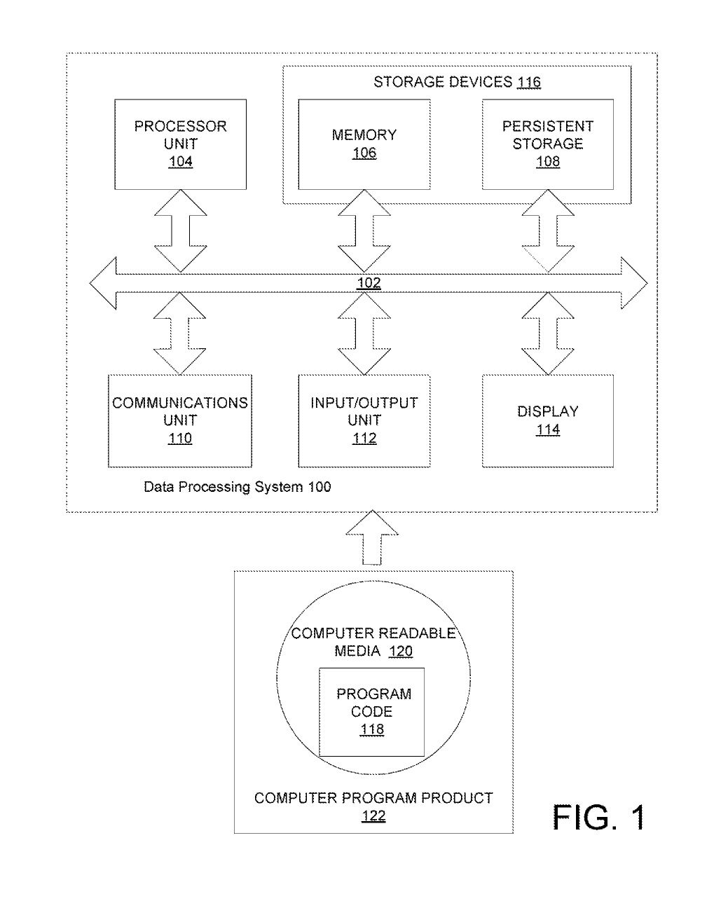

Turning now to FIG. 1 a block diagram of an exemplary data processing system operable for various embodiments of the disclosure is presented. In this illustrative example, data processing system 100 includes communications fabric 102, which provides communications between processor unit 104, memory 106, persistent storage 108, communications unit 110, input/output (I/O) unit 112, and display 114.

Processor unit 104 serves to execute instructions for software that may be loaded into memory 106. Processor unit 104 may be a set of one or more processors or may be a multi-processor core, depending on the particular implementation. Further, processor unit 104 may be implemented using one or more heterogeneous processor systems in which a main processor is present with secondary processors on a single chip. As another illustrative example, processor unit 104 may be a symmetric multi-processor system containing multiple processors of the same type.

Memory 106 and persistent storage 108 are examples of storage devices 116. A storage device is any piece of hardware that is capable of storing information, such as, for example without limitation, data, program code in functional form, and/or other suitable information either on a temporary basis and/or a permanent basis. Memory 106, in these examples, may be, for example, a random access memory or any other suitable volatile or non-volatile storage device. Persistent storage 108 may take various forms depending on the particular implementation. For example, persistent storage 108 may contain one or more components or devices. For example, persistent storage 108 may be a hard drive, a flash memory, a rewritable optical disk, a rewritable magnetic tape, or some combination of the above. The media used by persistent storage 108 also may be removable. For example, a removable hard drive may be used for persistent storage 108.

Communications unit 110, in these examples, provides for communications with other data processing systems or devices. In these examples, communications unit 110 is a network interface card. Communications unit 110 may provide communications through the use of either or both physical and wireless communications links.

Input/output unit 112 allows for input and output of data with other devices that may be connected to data processing system 100. For example, input/output unit 112 may provide a connection for user input through a keyboard, a mouse, and/or some other suitable input device. Further, input/output unit 112 may send output to a printer. Display 114 provides a mechanism to display information to a user.

Instructions for the operating system, applications and/or programs may be located in storage devices 116, which are in communication with processor unit 104 through communications fabric 102. In these illustrative examples the instructions are in a functional form on persistent storage 108. These instructions may be loaded into memory 106 for execution by processor unit 104. The processes of the different embodiments may be performed by processor unit 104 using computer-implemented instructions, which may be located in a memory, such as memory 106.

These instructions are referred to as program code, computer usable program code, or computer readable program code that may be read and executed by a processor in processor unit 104. The program code in the different embodiments may be embodied on different physical or tangible computer readable media, such as memory 106 or persistent storage 108.

Program code 118 is located in a functional form on computer readable media 120 that is selectively removable and may be loaded onto or transferred to data processing system 100 for execution by processor unit 104. Program code 118 and computer readable media 120 form computer program product 122 in these examples. In one example, computer readable media 120 may be in a tangible form, such as, for example, an optical or magnetic disc that is inserted or placed into a drive or other device that is part of persistent storage 108 for transfer onto a storage device, such as a hard drive that is part of persistent storage 108. In a tangible form, computer readable media 120 also may take the form of a persistent storage, such as a hard drive, a thumb drive, or a flash memory that is connected to data processing system 100. The tangible form of computer readable media 120 is also referred to as computer recordable storage media. In some instances, computer readable media 120 may not be removable.

Alternatively, program code 118 may be transferred to data processing system 100 from computer readable media 120 through a communications link to communications unit 110 and/or through a connection to input/output unit 112. The communications link and/or the connection may be physical or wireless in the illustrative examples. The computer readable media also may take the form of non-tangible media, such as communications links or wireless transmissions containing the program code.

In some illustrative embodiments, program code 118 may be downloaded over a network to persistent storage 108 from another device or data processing system for use within data processing system 100. For instance, program code stored in a computer readable storage medium in a server data processing system may be downloaded over a network from the server to data processing system 100. The data processing system providing program code 118 may be a server computer, a client computer, or some other device capable of storing and transmitting program code 118.

The different components illustrated for data processing system 100 are not meant to provide architectural limitations to the manner in which different embodiments may be implemented. The different illustrative embodiments may be implemented in a data processing system including components in addition to or in place of those illustrated for data processing system 100. Other components shown in FIG. 1 can be varied from the illustrative examples shown. The different embodiments may be implemented using any hardware device or system capable of executing program code. As one example, the data processing system may include organic components integrated with inorganic components and/or may be comprised entirely of organic components excluding a human being. For example, a storage device may be comprised of an organic semiconductor.

As another example, a storage device in data processing system 100 may be any hardware apparatus that may store data. Memory 106, persistent storage 108 and computer readable media 120 are examples of storage devices in a tangible form.

In another example, a bus system may be used to implement communications fabric 102 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 106 or a cache such as found in an interface and memory controller hub that may be present in communications fabric 102.

According to an illustrative embodiment, a computer-implemented process improves the quality of information submitted by software developers in timesheets, increases the developer productivity and accuracy in doing so, and makes this information more useful as a project management aid. A computer-implemented process, in one illustrative example, measures the activity performed on development artifacts in the course of a task as indicators of the relative amount of effort expended on that task. For example, when developers implement a new feature or fix a defect, they modify source code and the amount of change is an indicator of the effort. Other development artifacts including requirements, models, plans, and tests can also be used in this way.

The use of development artifacts to compute change metrics as an effort indicator is not invasive since it requires no instrumentation of the personal computer of the developer. Change metrics are computed from artifacts that have been stored in tool repositories, such as, source code control systems, change management systems, and other similar repositories. Measurement of the artifacts does not violate the privacy of the developer. In addition, using change metrics to assess effort is consistent with modern quantitative project management practices, which uses these metrics to monitor progress. The information assists developers in accurately reporting effort in timesheets, enables managers to assess the consistency of reported effort with change metrics, and provides quantitative information to support client billing.

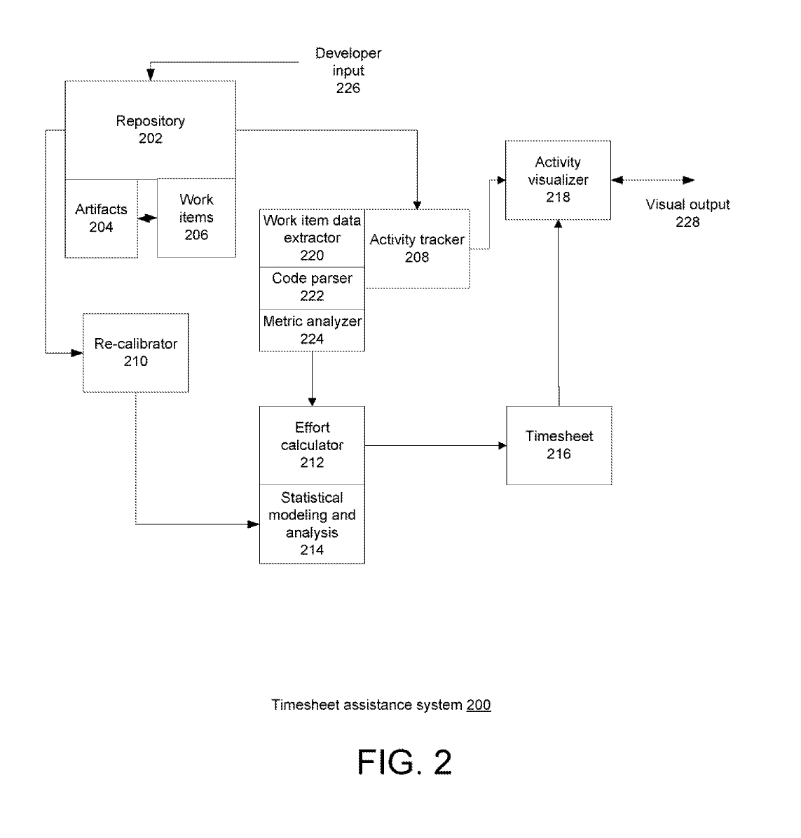

With reference to FIG. 2, a block diagram of components of a timesheet assistance system, in accordance with an embodiment of the present invention is illustrated. Timesheet assistance system 200, as an example, provides a capability to address specific characteristics of software development to make timesheet assistance practical. Using timesheet assistance system 200 enables programmatic extraction of an actual quantity of work performed by a software developer and prediction of effort associated with that work using statistical techniques.

Timesheet assistance system 200 comprises a number of components to leverage an underlying data processing system, such as data processing system 100 of FIG. 1 including, components of repository 202, activity tracker 208, Re-calibrator 210, effort calculator 212, statistical modeling and analysis 214, timesheet 216 and activity visualizer 218. Repository 202 provides a persistent storage capability for data including artifacts 204 and work items 206. Work items 206 represent a contiguous unit of work. For example, a work item may be a set of one or more tasks or activities forming a logical unit of work. Artifacts 204 are typically created by developer input 226 but may also be created by other processes such as programmatic processes.

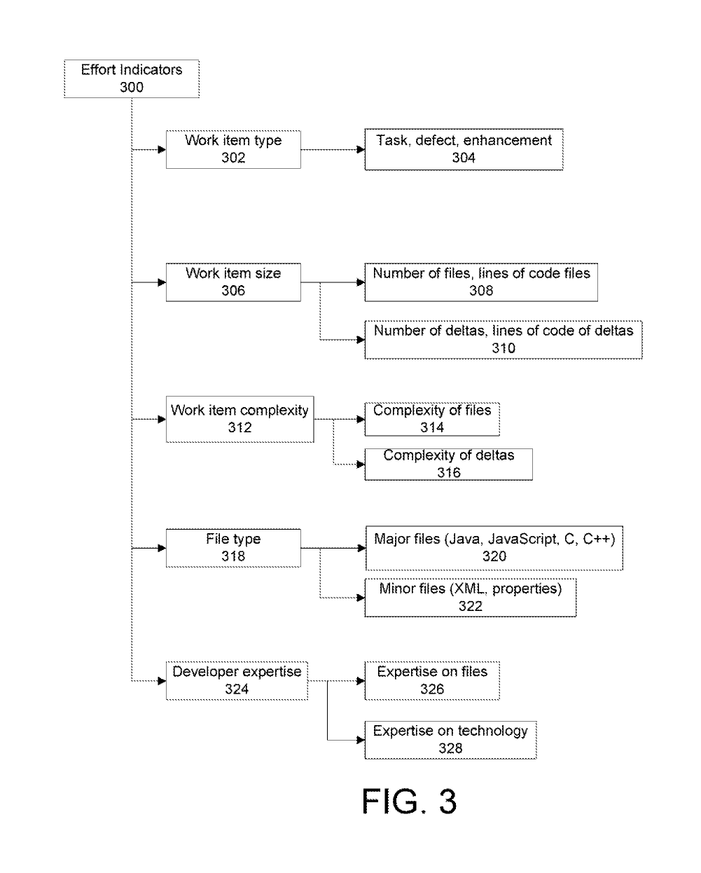

Activity tracker 208 extracts all work items 206 and related attributes of work items 206 that provide context of development activity and are indicative of effort spent on development activity. The development information is extracted from storage locations such as repository 202 for determining volume and complexity of work completed as well as familiarity or expertise of the developer with the work performed. While a work item may be any development activity including activities related to planning, requirements, and testing, in this example, a focus is placed on code related work items such as development tasks, enhancements and defects. FIG. 3 lists some examples of the factors that are typically indicative of the nature and scope of development activity or impact effort expended on a work item.

As shown in the example of timesheet assistance system 200, activity tracker 208 may be further comprised of work item data extractor 220, code parser 222, and metrics analyzer 224. Work item data extractor 220 uses application programming interfaces suited to the data repository to extract work item attributes such as type of work item, creator of the work item, owner, status, estimated effort and change sets associated with the work item. The next step is to identify volume and the complexity of changes made. For each file in the change set, before and after versions of the file are extracted, and changes made are identified, for example, using a source code difference detection utility. Code parser 222 parses the file and deltas (differences) and metrics analyzer 224 computes a set of metrics and stores the set of metrics in a data store, such as repository 202. Metrics analyzer 224 also uses historical work item data available in the repository to compute the expertise of the developer associated with a changed file and further for the work item as a whole.

The set of metrics may be one or more metrics, for example, lines of code defining non-commented lines of code, cyclomatic complexity used to measure a number of linearly-independent paths through a program unit (a measure of an amount of decision logic in a single software module), fan-out representing a number of other functions being called from a given program unit, number of methods representing a number of methods in a class including public, private and protected methods, and a number of deltas representing a contiguous block of code updates (added, changed or deleted).

Every project has a certain set of characteristics that could influence the work item effort. For a specific project, use of additional software engineering metrics may be required to analyze the complexity of change and the effort required. To allow metrics that can be configured and extracted by an activity tracker, an extension point is defined for adding additional metrics by extending an abstract-metric-provider of metrics analyzer 224. A metric can be used for different levels of granularity associated with a work item, a file and changes/deltas of files or work items. Activity tracker 208 extracts metrics computed by all extension points and generates an extensible markup language (XML) file for each work item containing name/value pairs of metrics.

Effort calculator 212 uses statistical analysis techniques to predict the amount of effort a developer has spent on a work item, such as work items 206, based on work item data and metrics information mined and computed by activity tracker 208 for historical tasks and effort reported for these tasks. Effort calculator 212 applies statistical analysis techniques to predict effort for subsequent tasks. In an example implementation linear regression is used to fit the effort curve to determine regression coefficients.

Re-calibrator 210 provides a capability to refine a regression model as more work item data is captured. Re-calibrator 210 computes regression coefficients, which are further used by effort calculator 212. As a project advances, the influence of factors on the effort for a work item changes. Familiarity of technology, stability of features through a development cycle and other factors may cause less effort to be expended for the same change as compared to the effort spent during the initial stages of the development cycle. On the other hand, in long-running projects, code decay can lead to an increase in change effort over time. In either case adaptation of the model to changes in the project environment is necessary. Starting with an existing model, as new work item data becomes available; Re-calibrator 210 periodically computes regression coefficients to align effort calculator 212 more closely with the existing project state.

Activity visualizer 218 is a visual component of timesheet assistance system 200 providing a view of timesheet 216. Timesheet 216 is a data structure representing a set of associated integrated data describing forms of effort allocated to various work products. Data mined by activity tracker 208 and effort computed by effort calculator 212 is presented in a form of timesheet 216 for viewing by a developer or a project manager. Timesheet 216 typically represents a summary view of time spent during a predefined period of time for a selected developer. Other views may be presented as well to reflect logical collections of information.

While timesheets have been used in the software industry previously the way timesheets are filled and managed may be improved using modern development environments, efficient archival and querying of the data in these environments by means of data warehouses, and use of business intelligence techniques that may be applied to such warehouses.

Integrated development environments (IDEs) have evolved into collaborative environments supporting project planning, work assignment, source code management, build and test management, project tracking and reporting. In these development environments each development task, whether planning, development, testing, or defect fix, is modeled as a work item expected to deliver a development plan, design, feature enhancement, or a code fix, as the case may be. Each work item consists of a set of basic attributes that are useful for tracking the work item including name, unique identifier, description, creator (name of a team member who created the work item), owner (name of the team member who is responsible for successfully completing the work item), creation date, closure date, project team name, priority, estimated effort, corrected effort and time spent. In addition, several custom attributes, for example, platform, sub-team, problem origin (in case of defects), iteration or release number can also be defined.

The real benefit of work items, however, comes from links that may be established between the work items and corresponding development activity performed. Each work item can be linked to software development artifacts including code, test cases, designs, plans, or other artifacts. A work item can be linked to files stored in a configuration management system through the definition of one or more change sets. A change set is a collection of files grouped together by the developer in a manner that is meaningful for the project. For example, all file changes related to a graphic user interface could be grouped together into a single change set. A changed file can be checked-in against one or more work items. The linking facility is particularly useful for defect work items, since a single set of changes to a file could potentially fix multiple defects simultaneously.

Data warehouses archive large volumes of data efficiently and support fast querying and retrieval of information. Data from the development tools can be extracted, transformed and loaded into data warehouses, and business intelligence techniques applied to get deeper insight to the status of a project and obtain various types of reports for more informed decision-making. For example, links from a plan work item to associated derived task or defect work items can lead to more detailed analysis of various factors such as total effort expended for realizing a plan, percentage of said total effort expended on defect fixing (could provide an indication of the amount of rework needed to correct errors) and other insights. A common data warehouse, such as repository 202, can potentially support broader analyses such as how many of the requirements (from a requirements tool) are currently under development (this may be determined by analyzing code artifacts from a development environment that are linked to plan items derived from those requirements), how much effort has been reported for implementing a set of requirements, and what has been the development impact of a design change.

Information mined by activity tracker 208 and effort predicted by effort calculator 212 is used to visualize timesheet 216. Activity visualizer 218 is a reporting component of timesheet assistance system 200. The developer and project manager are able to view tasks, task details and effort predicted for completing a task. When predicted effort does not match actual effort for an associated task, the developer can update the actual effort, which needs to be approved by the project manager. Typically the work items and effort spent for a task are listed for a developer. Effort predicted by effort calculator 212 is also presented. A details view typically provides a summary of files and the changes made, using a drill-down technique, provides details of changes made to each file. Size and complexity metrics are typically provided for each file providing a capability to help a project manager identify causes for time spent on a specific development activity.

In one example, activity visualizer 218 may be used to present timesheet information regarding a maintenance change, with a further capability of presenting details of the change using the drill-down technique, to the reviewer when requested.

In certain scenarios where there is significant time spent on learning new technology, libraries used or time spent discussing the task, predicted effort may not match actual effort. Using timesheet assistance system 200, a developer can record this time spent as preparation time. Currently, this information is typically used for recording and reporting purposes but may also be included in effort calculator 212 for scenarios where a developer has low expertise or where there are many discussions linked to a work item.

With reference to FIG. 3, a block diagram of factors typically impacting effort, in accordance with one embodiment of the present invention is presented. Effort indicators 300 are an example of a set of factors that may impact effort expended on a work item.

Work item type 302 represents a type of a work item. For example, a work item type may be one of a set 304 containing a defect, task, or an enhancement that influences the effort. In one example, for a same change in terms of number of lines of code, a defect could take a longer time than a task because the amount of existing code that needs to be considered before making a change.

Work item size 306 represents quantities in the form of files 308 or deltas 310. In the example of files 308, the size of the file updated and the size of the changes made directly impact the effort. The changes are identified by comparing the file in a current version to the same file in a previous version and detecting the lines changed, added and deleted. Reference to the contiguous blocks of code changes is made as deltas 310, which include counts of a number of deltas or a number of lines of code in deltas.

Work item complexity 312, representing a complexity of the files 314 being updated and the complexity of the changes made (deltas) 316, may influence the effort spent. The size and the complexity metrics typically extracted for each file and change in timesheet assistance system 200 of FIG. 2 were described previously.

File type 318 represents major files 320 and minor files 322. Typical software development projects manipulate files of different types. A core functionality of a system may be implemented in a major programming language, but there will also be accompanying miscellaneous minor files such as configuration and build scripts, properties files, XML files, HTML files, and other useful file types, that developers will update in the performance of assigned tasks. Effort required in changing a few lines of a file typically depends on a file type. For example, making a change to a properties file will in general, require far less time than an equal-sized change in a Java™ (Java is a trademark of Oracle Corp.) file. Hence, classifying changes by identifying types of files that have changed is an important factor in sizing work and estimating effort spent on a work item. For example, classifying files as “major” and “minor” for key development files and miscellaneous files respectively, may be used or an even more fine-grained classification system may be used.

Developer expertise 324 represents the expertise of the developer making the change as an important determinant of the effort required. In timesheet assistance system 200 of FIG. 2, expertise of a developer for a work item is based on historical information mined by activity tracker 208, also of FIG. 2. In one example, expertise of developer D, for each file linked to a work item, is computed as a proportion of the total code in the file that has been updated by D. The expertise of the developer for a work item is then a weighted average of the expertise on each file changed. The weight for each file is based on number of lines of code changed in the file to the total number of lines changed in all the files of the work item. Developer expertise computed in this way, for example, in timesheet assistance system 200, ranges between values of 0 and 1. In addition to such an analysis based on relative code contribution, a timeline of updates made by the developer would also indicate a familiarity with the file. The timeline relationship is based on a notion that expertise or knowledge of a developer about a file will decay with time when the developer does not regularly work on a file.

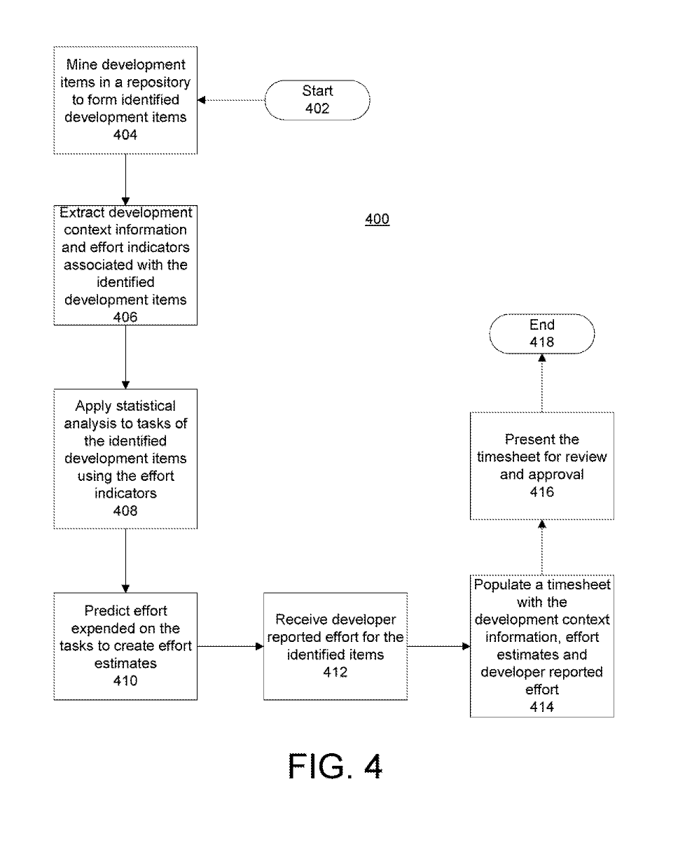

With reference to FIG. 4, a flowchart of a high level view of a process of timesheet assistance, in accordance with one embodiment of the present invention, is presented. Process 400 is an example of a process using timesheet assistance system 200 of FIG. 2. Process 400 analyzes information by first extracting all the tasks or work items a developer had worked on in a given period of time. Second, for each work item, process 400 mines files that were changed for information on the complexity of the files, and expertise of the developer on the changed files. Third, process 400 uses statistical techniques based on historical data in a repository, for example, using linear regression, to predict the time taken to complete the task (effort). Finally, a report of all the relevant information along with the associated activities is provided in a timesheet.

Process 400 starts (step 402) and mines development items in a repository to form identified development items (step 404). The repository may be a suitable storage location providing a capability to store, maintain and retrieve data representative of development work items, related attributes of work items that provide context of the development activity and are indicative of effort spent on an item. The repository may also contain source code. The repository is not limited to a single entity and may be one or more repositories to maintain information by location or category as required.

Process 400 extracts development context information and effort indicators associated with the identified development items (step 406).

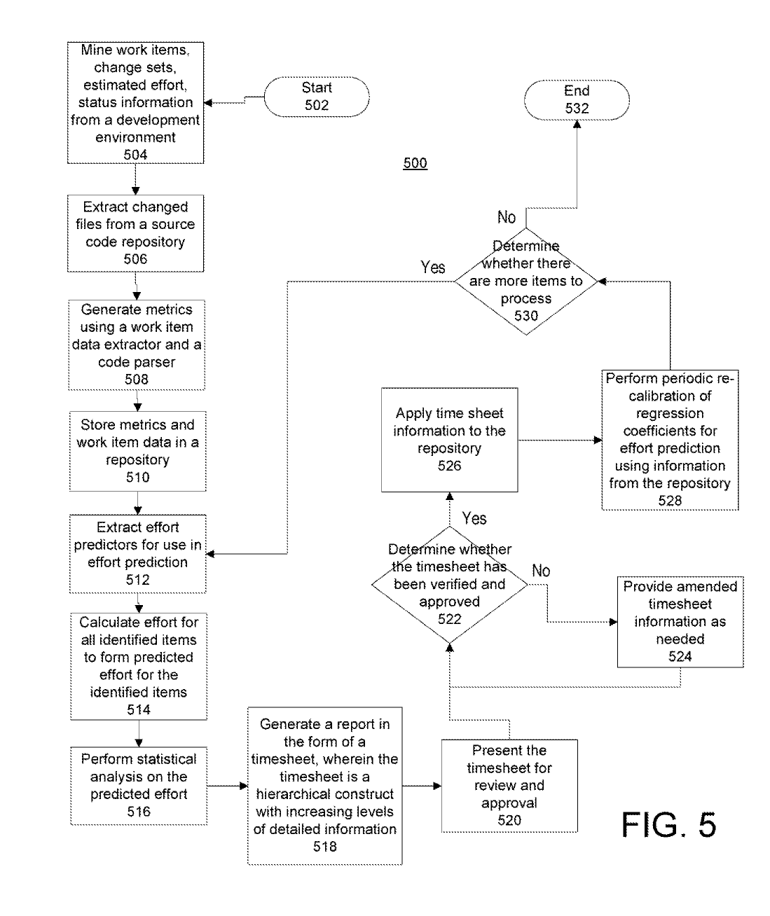

With reference to FIG. 5, a flowchart of a detail view of the process of timesheet assistance of FIG. 4, in accordance with one embodiment of the present invention is presented. Process 500 is a further example of a process using the components of timesheet assistance system 200 shown in greater detail than process 400 of FIG. 4.

Process 500 starts (step 502) and mines work items, change sets, estimated effort, and status information from a development environment (step 504). A developer creates the information mined typically during the course of work to create and own work items, to make changes and submit source code.

Process 500 extracts changed files from a source code repository (step 506). A source code repository may be a separate storage area or combined with one or more storage areas or repositories as required. Process 500 generates metrics, for the extracted information, using a work item data extractor and a code parser (step 508). The code parser is used with the source code files and the work item data extractor is used with the work item data information. Process 500 stores the metrics and work item data in a repository (step 510). The repository may be the same repository used previously or a separate repository, as required.

Process 500 extracts effort predictors for later use in effort prediction (step 512). Effort predictors are typically indicators of volume and complexity of work done. Calculation of effort for all identified items in the work item data extraction is performed by process 500 to create predicted effort for the identified items (step 514). Process 500 performs statistical analysis on the predicted effort (step 516). For example, an effort calculator performs calculations on development information derived by an activity tracker for historical tasks and time reported. The statistical analysis are applied to determine a time curve and to predict effort for subsequent tasks.

Process 500 generates a report in the form of a timesheet (step 518). Process 500 presents the timesheet for review and approval (step 520). Timesheet information is presented in a hierarchical manner allowing increasing levels of detail to be viewed as well as links to artifacts in the repository of development information. New tasks have information presented as “estimated actuals” to note the lack of historical perspective information. Process 500 determines whether the timesheet has been verified and approved (step 522). When a determination is made that the timesheet has been verified and approved, a “yes” result is obtained. When a determination is made that the timesheet has not been verified and approved, a “no” result is obtained. When a “no” result is obtained in step 522, process 500 provides amended timesheet information as needed (step 524) with process 500 looping back to perform step 522 again.

When a “yes” result is obtained in step 522, process 500 applies timesheet information to the repository (step 526). Process 500 performs periodic re-calibration of regression coefficients for effort prediction using information from the repository of development information (step 528). In this manner an effort curve can be continuously recalibrated using new data points as they become available from new tasks and approved timesheet information.

Process 500 determines whether there are more items to process (step 530). When a determination is made that there are more items to process, a “yes” result is obtained. When a determination is made that there are no more items to process, a “no” result is obtained. When a “yes” result is obtained, process 500 loops back to perform step 512 as before. When a “no” result is obtained, process 500 terminates (step 532).

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for preparing a timesheet in a software development environment, comprising:
mining, using a processor, development items in a repository of a computer to form identified development items;
extracting, using said processor, development context information, and effort indicators associated with said identified development items;
applying, using said processor, statistical analysis to tasks of said identified development items using said effort indicators;
predicting effort expended on said tasks using historical data to create effort estimates;
receiving developer reported effort for the identified items;
generating a timesheet using said development context information, said effort estimates and said developer reported effort; and
presenting said timesheet for review, verification, and approval.

2. The method of claim 1 wherein mining development items in said repository to form said identified development items further comprises:
mining work items, change sets, estimated effort and status information from a repository of information for a development environment, wherein said work items, change sets, estimated effort and status information describe a volume and complexity of work done and expertise of a developer associated with the work.

3. The method of claim 1 wherein extracting development context information and effort indicators associated with said identified development items further comprises:
extracting changed files from a source code repository; and
extracting effort predictors for use in effort prediction.

4. The method of claim 1 wherein applying statistical analysis to tasks of said identified development items using said effort indicators further comprises:
generating metrics using a work item data extractor and a code parser to determine a time curve and predict effort for subsequent tasks.

5. The method of claim 1 wherein predicting effort expended on said tasks to create effort estimates further comprises:
calculating effort for all said identified development items to form predicted effort thereof; and
performing statistical analysis on said formed predicted effort.

6. The method of claim 1 wherein generating said timesheet using said development context information, said effort estimates and said developer reported effort further comprises:
generating a report in the form of a timesheet, wherein information in the report is in a hierarchical construct with increasing levels of detailed information and including as input additional indications of effort for tasks not represented by artifacts in the repository and assigning tasks to categories based on comparability of effort requirements.

7. The method of claim 1, further comprising:
determining whether said timesheet has been verified and approved;
responsive to a determination that said timesheet has been verified and approved, applying timesheet information to a repository;
using linear regression to fit an effort curve and determine regression coefficients; and
performing periodic re-calibration of said coefficients as more data on said tasks of said identified development items is captured for effort prediction using information from said repository.
